(19) United States
(12) Patent Application Publication
(10) Pub. No.: US 2008/0101205 A1
(43) Pub. Date: May 1, 2008

(54) OPTICAL DISC APPARATUS AND LASER-POWER CONTROL METHOD THEREFOR

(75) Inventors: Takashi Usui, Tokyo (JP); Kazuto Kuroda, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABISHIKI KAISHA TOSHIBA, Tokyo (JP)

(21) Appl. No.: 11/928,123

(22) Filed: Oct. 30, 2007

(30) Foreign Application Priority Data
Oct. 31, 2006 (JP) 2006/296851

(51) Int. Cl. G11B 7/00

(52) U.S. Cl. 369/121

(57) ABSTRACT

An optical disc apparatus includes a laser-light emitting element configured to emit laser light onto a writable and readable optical disc, a power detecting unit configured to detect a light power of the laser light emitted from the laser-light emitting element, and a power control unit configured to control a driving amount for the laser-light emitting element by feedback control so that the detected light power coincides with a target light power. The power control unit holds a driving amount obtained during a previous recording period until a current recording period, and uses the held driving amount as an initial driving amount for the feedback control in the current recording period when the current recording period starts.

### CROSS-REFERENCE TO RELATED APPLICATIONS

This application claims the benefit of priority of Japanese Patent Application No. 2006-296851, filed Oct. 31, 2006, the entire contents of which are incorporated herein by reference.

### BACKGROUND

1. Field

The present invention relates to an optical disc apparatus and a laser-power control method therefor, and more particularly, to a disc apparatus that performs recording and playback of an optical disc with a laser, and to a laser-power control method for the apparatus.

2. Description of the Related Art

In a recordable optical disc such as a CD-R, a CD-RW, a DVD-R, a DVD-RW, a DVD-RAM, an HD DVD-R, an HD DVD-RAM, or an HD DVD-RW, tracks including grooves and lands are provided on a surface of the disc, and marks and spaces corresponding to recording data are formed by irradiating laser light with recording laser power onto the tracks.

For playback of the optical disc, a playback laser power that is weaker than the recording laser power is used. That is, different laser powers are used in recording and playback.

In general, a laser diode is used as a laser light source for an optical disc. However, it is known that the power of light emitted from the laser diode varies with temperature and operating time. There is a need to maintain a predetermined power of light emitted from the laser diode in order to form marks and spaces in proper shapes. For that purpose, an optical disc apparatus normally performs laser power control such as APC (auto power control). The laser power control constantly ensures a predetermined light power.

Laser power control, such as APC, is normally exerted with a feedback loop so that a monitored light power of the laser coincides with a desired light power (target value).

For this reason, for example, immediately after a playback mode is switched to a recording mode, a transient response of the feedback loop occurs.

The period of transient response is an unstable period in which the light power of the laser diode does not coincide with the target value. Therefore, a light power having an accuracy necessary for forming a recording mark is not obtained in this period, and the quality of recording on the optical disc is lowered. Not only the recording quality is simply lowered, but also it is conceivable that a servo error signal will be lost by a temporary break of the light power and that track servo control and focus servo control on the optical disc will become unstable.

Moreover, when the target value of the light power is set at a relatively high value, a monitor circuit may be saturated by overshooting in the transient response and the feedback loop may diverge.

When a recording mode is switched to a playback mode, a transient response similarly occurs. This lowers the quality of a reproduction signal, and decreases stability of servo control.

In order to overcome these problems, for example, JP-A 06-342527 discloses a technique of controlling the laser power for a recordable optical disc.

In this technique, a laser diode is driven by a predetermined driving current corresponding to a target light power during a transient response, and a feedback loop is closed after the completion of the transient response. That is, open-loop control and closed-loop control are combined.

However, feedback loop control, such as APC, originally aims to prevent the driving-current to light-power characteristic of the laser diode, which indicates the relationship between the driving current and the light power, from varying with temperature and operating time. Open-loop control that does not monitor the actual light power is exerted on the assumption that the driving-current to light-power characteristic does not greatly vary with temperature or the like, and the accuracy of the light power is not always sufficient during the open-loop control.

### SUMMARY OF THE INVENTION

The present invention has been made in view of the above-described circumstances, and an object of the invention is to provide an optical disc apparatus in which variations in light power of a laser due to a transient response can be reduced and a target light power can be achieved with high accuracy even immediately after a playback mode is switched to a recording mode or even immediately after a recording mode is switched to a playback mode, and to provide a laser-power control method for the apparatus.

In order to solve the above-described problems, an optical disc apparatus according to an aspect of the present invention includes a laser-light emitting element configured to emit laser light onto a writable and readable optical disc; a power detecting unit configured to detect a light power of the laser light emitted from the laser-light emitting element; and a power control unit configured to control a driving amount for the laser-light emitting element by feedback control so that the detected light power coincides with a target light power. The power control unit holds a driving amount obtained during a previous recording period until a current recording period, and uses the held driving amount as an initial driving amount for the feedback control in the current recording period when the current recording period starts.

A laser-power control method according to another aspect of the present invention includes the steps of emitting laser light from a laser-light emitting element onto a writable and readable optical disc; detecting a laser power of the laser light emitted from the laser-light emitting element; and controlling a driving amount for the laser-light emitting element by feedback control so that the detected light power coincides with a target light power. In the control step, a driving amount obtained during a previous recording period is held until a current recording period, and the held driving amount is used as an initial driving amount for the feedback control in the current recording period when the current recording period starts.

According to the optical disc apparatus and the laser-power control method of the present invention, it is possible to reduce variations in light power of the laser due to a transient response and to achieve a target light power with high accuracy even after a playback mode is switched to a recording mode or even immediately after a recording mode is switched to a playback mode.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a structural view showing a configuration of an optical disc apparatus according to an embodiment of the present invention;

FIG. 2 is a chart schematically showing changes in power of laser light emitted from a laser-light emitting element in the optical disc apparatus;

FIG. 3 is a structural view showing a detailed configuration of a laser driving device in the optical disc apparatus;

FIG. 4 is an explanatory view showing a laser-power control method according to the embodiment; and

FIG. 5 is a flowchart showing the laser-power control method.

### DETAILED DESCRIPTION

An optical disc apparatus and a laser-power control method according to an embodiment of the present invention will be described with reference to the attached drawings.

(1) Configuration of Optical Disc Apparatus

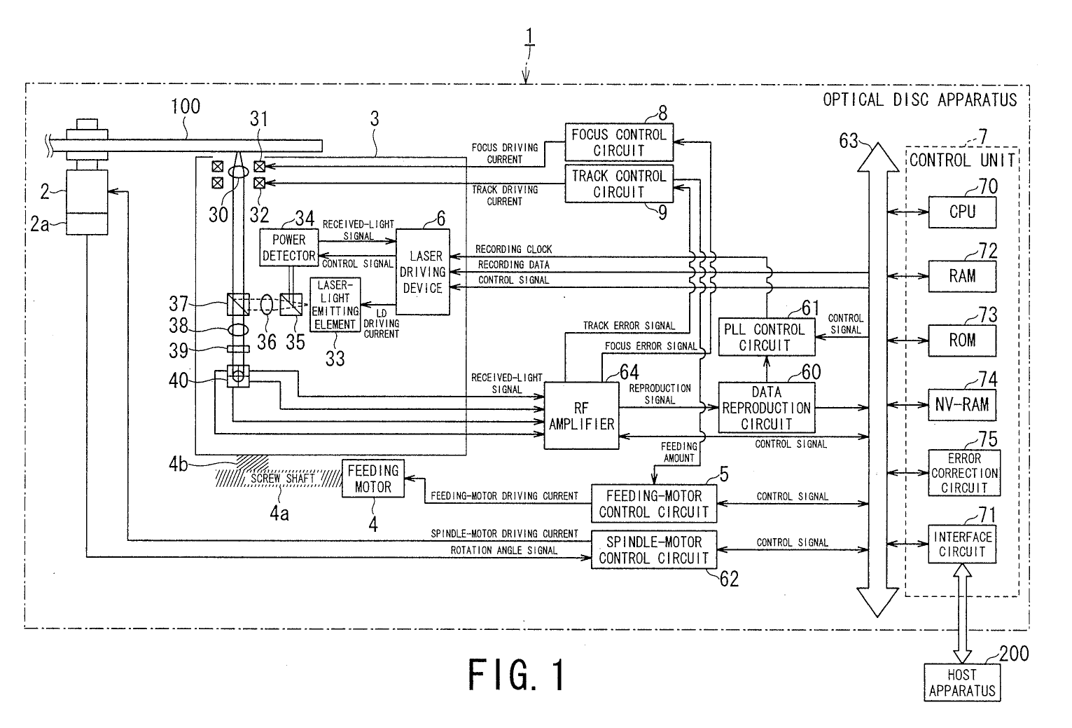

FIG. 1 shows a configuration of an optical disc apparatus 1 according to this embodiment.

The optical disc apparatus 1 records and reproduces information on and from an optical disc 100, such as a DVD (digital versatile disc), that is, an information storage medium. Tracks including convex portions called lands and concave portions called grooves are provided in a spiral form on the optical disc 100. User data is recorded as recording marks by irradiating intensity-modulated laser light along the tracks (only grooves, or grooves and lands).

Data reproduction is performed by irradiating laser light having a read power, which is weaker than the power used for recording, along the tracks and detecting changes in intensity of light reflected by the recording marks on the tracks. Recorded data is erased by irradiating laser light having an erase power stronger than the read power along the tracks so as to crystallize a recording layer.

The optical disc 100 is rotated by a spindle motor 2. A rotation angle signal is supplied from a rotary encoder 2a provided on the spindle motor 2. For example, when the spindle motor 2 makes one rotation, the rotary encoder 2a generates five pulses as the rotation angle signal. The rotation angle and rotation speed of the spindle motor 2 can be detected from the rotation angle signal. A spindle-motor control circuit 62 controls the rotation of the spindle motor 2 on the basis of the detected rotation angle and rotation speed.

Information recording and reproduction for the optical disc 100 are performed with an optical pickup 3. The optical pickup 3 is connected to a feeding motor 4 via a gear 4b and a screw shaft 4a. The feeding motor 4 is controlled by a feeding-motor control circuit 5. The feeding motor 4 is rotated by a feeding-motor driving current from the feeding-motor control circuit 5, and the optical pickup 3 is thereby moved in the radial direction of the optical disc 100.

The optical pickup 3 includes an objective lens 30 supported by a wire or a leaf spring (not shown). The objective lens 30 can be moved in the focusing direction (along the lens optical axis) by driving a driving coil 31, and in the tracking direction (in a direction orthogonal to the lens optical axis) by driving a driving coil 32.

In information recording (mark formation), a laser driving device 6 supplies a driving current for writing to a laser-light emitting element (laser diode) 33 on the basis of recording data supplied from a host apparatus 200, such as a personal computer, via an interface circuit 71 in a control unit 7. In information reading, the laser driving device 6 supplies a driving current for reading, which is smaller than the writing driving current, to the laser-light emitting element 33. A detailed configuration of the laser driving device 6 will be described below.

A predetermined part of laser light emitted from the laser-light emitting element 33 is caused by a half mirror 35 to branch off, and a power detector 34 (sometimes referred to as a front monitor (FM)), such as a photodiode, receives the light part and detects, as a received-light signal, a signal proportional to the amount of the received light part, that is, light power. The detected received-light signal is supplied to the laser driving device 6. According to the received-light signal from the power detector 34, the laser driving device 6 controls the laser-light emitting element 33 so as to emit laser light with a read power, a write power, and an erase power set by the control unit 7.

The laser-light emitting element 33 emits laser light in accordance with a driving current supplied from the laser driving device 6. The laser light emitted from the laser-light emitting element 33 is applied onto the optical disc 100 via a collimator lens 36, a half prism 37, and the objective lens 30.

In a reverse direction, light reflected from the optical disc 100 is guided to a photodetector 40 via the objective lens 30, the half prism 37, a light-collecting lens 38, and a cylindrical lens 39.

For example, the photodetector 40 includes four photosensor cells. Detection signals from the photosensor cells are output to an RF amplifier 64. The RF amplifier 64 processes the signals from the photosensor cells, and generates a focus error signal FE indicating an error from the focus, a tracking error signal TE indicating an error between the center of a beam spot of the laser light and the track center, and a reproduction signal RF serving as a sum signal indicating the sum of the signals from the photosensor cells.

The focus error signal FE is supplied to a focus control circuit 8. According to the focus error signal FE, the focus control circuit 8 generates a focus driving signal, and supplies the focus driving signal to the driving coil 31 for the focusing direction. Consequently, focus servo control is exerted so that laser light is always properly focused on the recording film of the optical disc 100.

The tracking error signal TE is supplied to a track control circuit 9. According to the tracking error signal TE, the track control circuit 9 generates a track driving signal, and supplies the track driving signal to the driving coil 32 for the tracking direction. Consequently, tracking servo control is exerted so that the laser light constantly traces the tracks provided on the optical disc 100.

The focus servo control and tracking servo control described above allow the spot of laser light to precisely trace the tracks on the recording surface of the optical disc 100. As a result, changes of light reflected from marks and spaces provided on the tracks of the optical disc 100 corresponding to recording information are precisely reflected in the sum signal RF indicating the sum of the signals output from the photosensor cells, and a high-quality reproduction signal can be obtained. The reproduction signal (sum signal RF) is supplied to a data reproduction circuit 60. The data reproduction circuit 60 reproduces recording data on the basis of reproduction clock signals from a PLL control circuit 61.

When the objective lens 30 is controlled by the track control circuit 9, the feeding motor 4 is driven by the feeding-motor control circuit 5 to control the position of the optical pickup 3 in the radial direction so that the objective lens 30 is placed near a predetermined position on the recording surface of the optical disc 100.

The feeding-motor control circuit 5, the laser driving device 6, the RF amplifier 64, the focus control circuit 8, the track control circuit 9, the data reproduction circuit 60, the PLL circuit 61, and the spindle-motor control circuit 62 are connected to the control unit 7 via a bus 63. The control unit 7 includes a CPU 70 that controls the entire optical disc apparatus 1 according to operation commands supplied from the host apparatus 200 via the interface circuit 71. The CPU 70 uses a RAM 72 as a work area, and executes programs stored in a ROM 73.

While the light power of the laser-light emitting element 33 is directly controlled by the laser driving device 6, the laser driving device 6 is controlled according to a control signal from the control unit 7. That is, a power control unit that substantially controls the light power is constituted by the laser driving device 6 and the control unit 7.

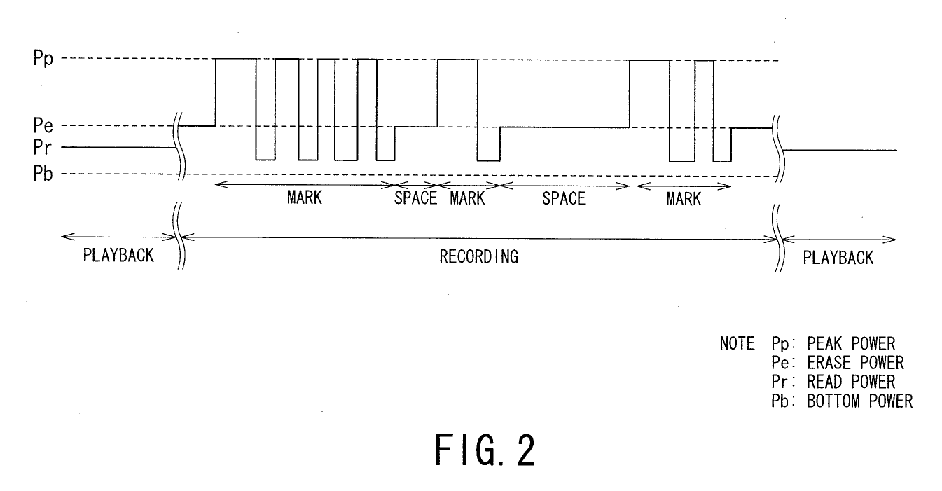

FIG. 2 schematically shows changes in the power of laser light emitted from the laser-light emitting element 33 in the optical disc apparatus 1 according to this embodiment. The optical disc apparatus 1 records data on the optical disc 100 by a multi-pulse method in which a plurality of sub-pulses are generated when forming a recording mark. During data recording (writing), the laser-light emitting element 33 alternately and repetitively generates a light power called a peak power and a light power called a bottom power, and forms recording marks on the track of the optical disc 100, as shown in FIG. 2. Specifications, such as the number and width of sub-pulses generating the peak power and the bottom power, and combinations thereof are generally called a strategy or a write strategy. The strategy or write strategy is standardized in accordance with the type of the optical disc 100.

In order to erase recording data, the laser-light emitting element 33 generates an erase power weaker than the peak power so as to crystallize the recording layer of the optical disc 100 and to thereby form a space (that is, erase a recording mark).

In contrast, during data reproduction (reading), the laser-light emitting element 33 continuously generates a light power called a read power. Since the read power is weaker than the erase power, it does not change the phase state of the recording layer.

The peak power, the bottom power, the erase power, and the read power, and the generation timings thereof are controlled by the power control unit, more directly, by the laser driving device 6.

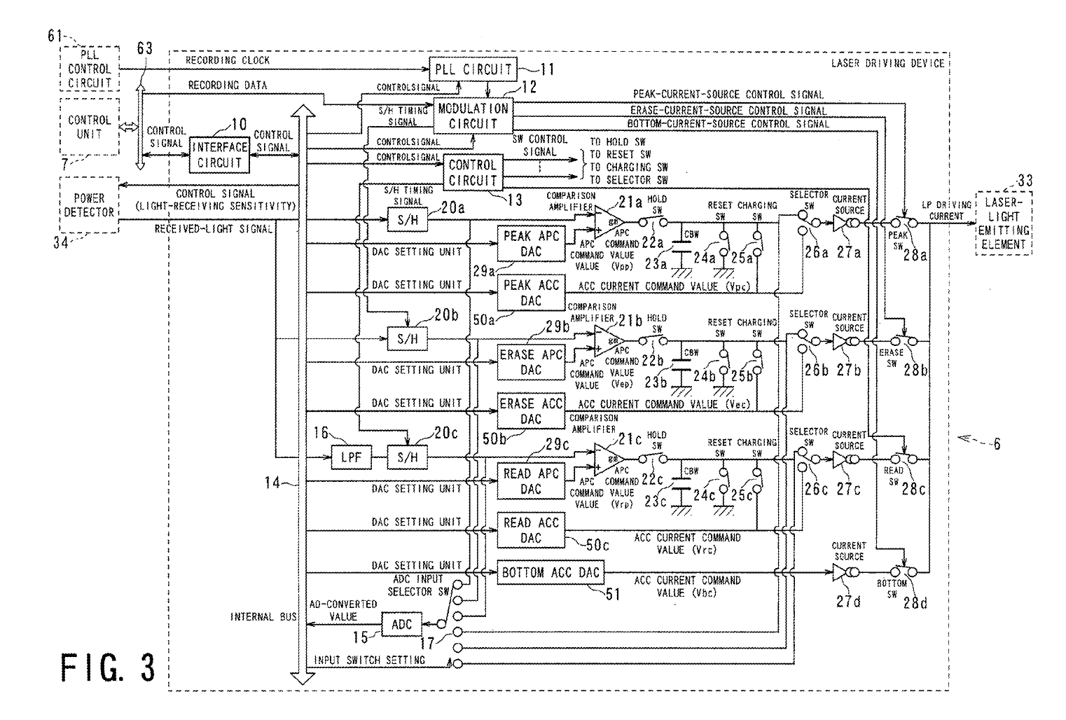

FIG. 3 shows a detailed configuration of the laser driving device 6. The laser driving device 6 includes four driving current sources (voltage-current conversion units) 27a, 27b, 27c, and 27d that cause the laser-light emitting element 33 to output the above-described peak power, bottom power, erase power, and read power.

The function of the laser driving device 6 can be roughly classified in three.

A first function is to generate a recording waveform from a recording clock and recording data during recording, and to switch among the three driving current sources 27a, 27b, and 27d for recording (for a peak power, an erase power, and a bottom power) at the timing corresponding to the recording waveform.

A second function is to exert APC (auto power control) on the peak power, the erase power, and the read power so that the powers coincide with target light powers designated by the CPU 70 during recording and playback, and to control a driving current to the laser-light emitting element 33 by exerting ACC (auto current control) on the bottom power.

A third function is to interpret control signals from the signal bus 63, and to control the components in the laser driving device 6.

The first function is carried out by a PLL circuit 11 and a modulation circuit 12. The PLL circuit 11 receives the recording clock, and generates various timing signals necessary for the modulation circuit 12. The modulation circuit 12 interprets the recording data, generates a recording waveform according to a control signal set by an internal bus 14, and divides the recording waveform into three current-source control signals used to turn on and off the driving current sources 27a, 27b, and 27d for the peak power, the erase power, and the bottom power. The current-source control signals are respectively input to a peak switch 28a, an erase switch 28b, and a bottom switch 28d. By turning on and off the driving current sources according to the current-source control signals, the driving current for the laser-light emitting element 33 is switched, and three types of light powers, namely, a peak power, an erase power, and a bottom power, are output from the laser-light emitting element 33, as shown in FIG. 2.

A read switch 28c for the driving current source 27c is mainly turned on only during playback. The control circuit 13 turns on and off the read switch 28c according to a recording/playback switch signal included in the control signal supplied from the signal bus 63.

In the peak power system, the erase power system, and the read power system, APC serving as the second function is exerted with a similar structure and in a similar manner. Herein, a structure and an operation of the erase power system will be described as an example.

In the following description, it is assumed that the erase switch 28b and a hold switch 22b are on, a reset switch 24b and a charging switch 25b are off, and a selector switch 26b is set to a side of a comparison amplifier (error detector) 21b.

The power of light emitted from the laser-light emitting element 33 is detected by the power detector 34, and is input as a received-light signal to the laser driving device 6. The input received-light signal is sampled and held by a sample-and-hold circuit 20b. As shown in FIG. 2, the erase power is switched in a short period. Therefore, in order to precisely obtain the erase power, the received-light signal is sampled in synchronization with the actual output timing of the erase power, and the sampled received-light signal is held in other periods. The received-light signal sampled and held by the sample-and-hold circuit 20b is input to one input terminal of the comparison amplifier 21b.

On the other hand, a target erase power is input from the CPU 70 of the control unit 7 to the laser driving device 6 via the signal bus 63, and is then set in an erase APC DAC 29b via an interface circuit 10 and the internal bus 14. A voltage (APC command value) corresponding to the target erase power is output from the erase APC DAC 29b, and is input to the other input terminal of the comparison amplifier 21b.

In feedback control of APC, the driving current for the erase power is controlled so that the voltages at the two input terminals of the comparison amplifier 21b are equal to each other. For example, when the voltage corresponding to the received-light signal is lower than the APC command value, the amount of current from the driving current source 27b for the erase power is increased. Conversely, when the voltage corresponding to the received-light signal is higher than the APC command value, the amount of current from the driving current source 27b is decreased.

In this case, the amount of current from the driving current source 27b is controlled by the potential of a capacitor 23b provided on the output side of the comparison amplifier 21b.

The third function is to transmit a control signal from the CPU 70 of the control unit 7 to the components in the laser driving device 6, and is carried out by the interface circuit 10, the internal bus 14, and the control circuit 13.

With recent increases in recording speed, the laser driving device 6 is sometimes mounted in the form of one IC in the optical pickup 3 in order to ensure the quality of the recording waveform, as shown in FIG. 1. Alternatively, a manner that has been popularly used may be adopted, that is, only the driving current sources 27a, 27b, 27c, and 27d, the peak switch 28a, the erase switch 28b, the read switch 28c, and the bottom switch 28d in the laser driving device 6 may be mounted in the optical pickup 3, and other components may be mounted outside the optical pickup 3.

While one laser-light emitting element 33 is connected to the laser driving device 6 in FIGS. 1 and 3, a plurality of laser-light emitting elements 33 are connected to the laser driving device 6 when the optical disc apparatus 1 performs recording and reproduction on and from a plurality of recording media, such as a CD, a DVD, and an HD DVD, corresponding to different wavelengths. In this case, the laser-light emitting elements 33 do not simultaneously emit light, and therefore, the operation of the laser driving device 6 is not different from that performed when one laser-light emitting element 33 is connected thereto.

The configuration of the laser driving device 6 and the setting states of the switches described above are similar to those adopted in the related art. However, in the related art, the hold switch 22b, the reset switch 24b, the charging switch 25b, and the selector switch 26b are not provided, and the output terminal of the comparison amplifier 21b is directly connected to the capacitor 23b and the driving current source 27b. This configuration is substantially equivalent to the above-described setting states of the switches.

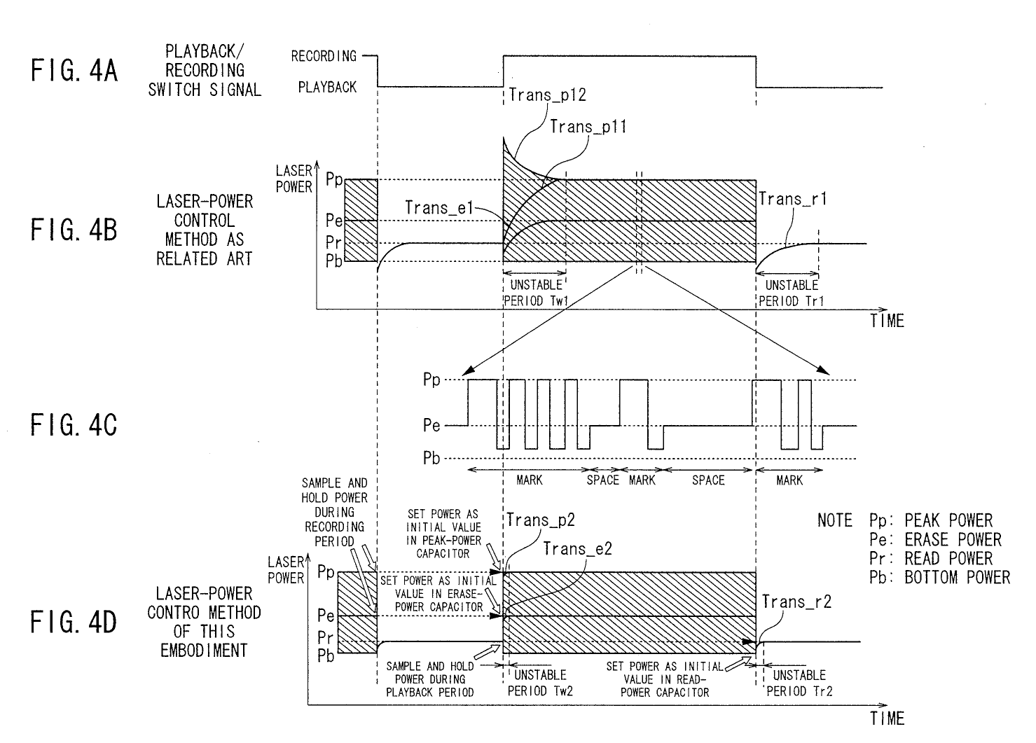

FIGS. 4A to 4C explain an APC operation in the related art. The APC operation and its problems will be described with reference to the figures.

FIG. 4A shows the timing of switching between a playback mode and a recording mode. Switching between the playback mode and the recording mode is made in response to a playback/recording switch signal of the control signals output from the control unit 7.

FIG. 4B shows the power levels of the light emitted form the laser-light emitting element 33. An emission pattern shaped like a multi-pulse in FIG. 4C is expressed by a diagonally shaded portion in FIG. 4B by being compressed along the time axis. Pp, Pe, Pr, and Pb respectively represent a target peak power, a target erase power, a target read power, and a target bottom power.

At the moment when the playback/recording switch signal is switched from a playback mode to a recording mode, APC on the peak power system and the erase power system starts. However, in the APC operation of the related art, transient changes Trans_p11 and Trans_e1 are caused by the transient response of feedback control before the peak power and the erase power come into the allowable ranges of the target peak power and the target erase power. This is because the inputs to the driving current sources are normally reset to zero at the start of the APC operation, and response delay corresponding to the time constant of the feedback loop occurs before the peak power and the erase power increase from zero to the target peak power and the target erase power.

As described in JP-A 06-342527, ACC using open loop control may be exerted for a predetermined period after the start of recording. However, with open loop control, it is difficult to obtain a proper initial power corresponding to a precise target peak power, therefore a transient change Trans_p12 shown in FIG. 4B sometimes occurs.

Because of these transient changes, an unstable period Tw1 occurs in which a power necessary for forming a recording mark is not obtained in a certain time after the start of recording. In the unstable period Tw1, it is conceivable that not only the recording quality will be lowered, but also a servo error signal will be lost by a temporary break of the power and servo control becomes unstable.

When a recording mode is switched to a playback mode, an unstable period Tr1 is also caused by a transient change Trans_r1 for a similar reason, and this lowers the quality of the reproduction signal and makes servo control unstable. Further, if an excessively large target peak power is set as a result of recording-power optimization learning performed separately, the power detector 34 (front monitor) for detecting the light power may be saturated, and the APC loop may diverge.

In order to solve this problem, in this embodiment, the hold switches 22a, 22b, 22c, the reset switches 24a, 24b, 24c, the charging switches 25a, 25b, 25c, and the selector switches 26a, 26b, 26c are respectively provided in the peak power system, the erase power system, and the read power system.

Further, the peak power system, the erase power system, and the read power system respectively include a peak ACC DAC 50a, an erase ACC DAC 50b, and a read ACC DAC 50c. Each DAC converts an initial APC value set by the CPU 70 of the control unit 7 from digital to analog, and outputs the converted value to the charging switch 25a, 25b, or 25c and the selector switch 26a, 26b, or 26c.

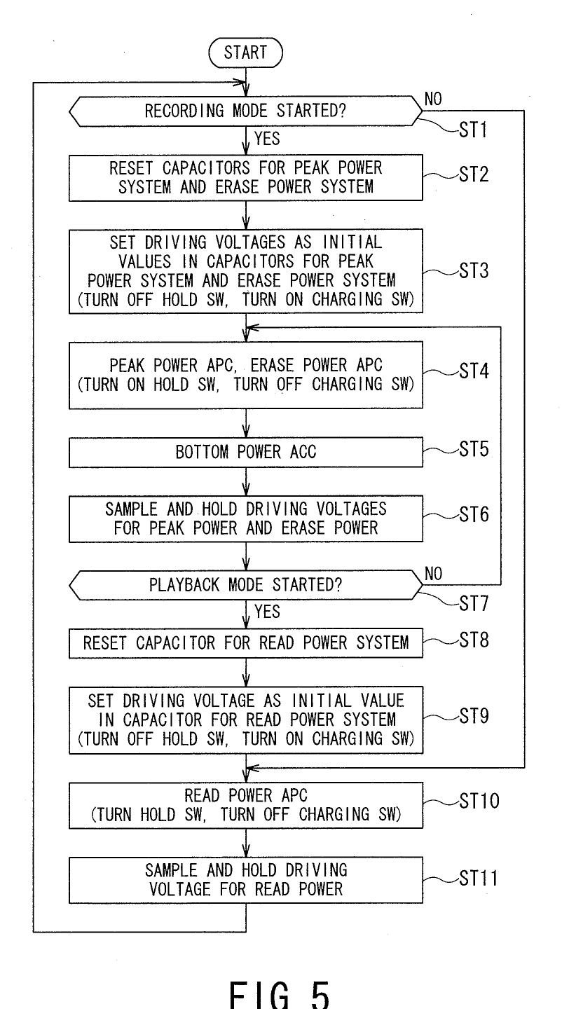

The above-described configuration in this embodiment reduces the transient changes in the APC operation, as shown in FIG. 4D. The APC operation will now be described with reference to FIG. 5 as a flowchart.

First, in Step ST1, it is determined whether a recording mode (current recording period) has started. This determination is made on the basis of a playback/recording switch signal output from the control unit 7.

When the recording mode starts, the control circuit 13 temporarily closes the reset switches 24a and 24b of the peak power system and the erase power system so as to reset the charges stored in the capacitors 23a and 23b. Subsequently, the control circuit 13 opens the reset switches 24a and 24b (Step ST2).

Next, the control circuit 13 closes the charging switches 25a and 25b, and opens the hold switches 22a and 22b (Step ST3). As a result, voltages corresponding to the initial APC values set in the peak ACC DAC 50a and the erase ACC DAC 50b are accumulated in the capacitors 23a and 23b via the charging switches 25a and 25b. These steps ST2 and ST3 can be performed during playback before Step ST1.

The initial APC value set in the peak ACC DAC 50a is a voltage at the input terminal of the driving current source 27a at the completion of the previous recording mode (a previous recording period, an immediately preceding recording period). That is, the initial APC value Ip_{O}(n) set in the peak ACC DAC 50a in the current recording mode is expressed by the following equation:
Ip_{O}(n)=Ip_{L}(n−1) (1)
where Ip_{L}(n−1) represents the peak power driving amount provided at the completion of the previous recording mode. This setting is made by the CPU 70 of the control unit 7.

Similarly, a voltage at the input terminal of the driving current source 27b at the completion of the previous recording mode is set as the initial APC value in the erase ACC DAC 50b. That is, the initial APC value Ie_{O}(n) set in the erase ACC DAC 50b in the current recording mode is expressed by the following equation:
Ie_{O}(n)=Ie_{L}(n−1) (2)
where Ie_{L}(n−1) represents the erase power driving amount provided at the completion of the previous recording mode. This setting is also made by the CPU 70 of the control unit 7.

Subsequently, the charging switches 25a and 25b are opened, and the hold switches 22a and 22b are closed, so that APC on the peak power system and the erase power system is started (Step ST4).

In this case, as the APC operation for the systems, feedback control is started by using the driving amounts provided at the completion of the previous recording mode as initial values. Therefore, the initial values are obtained after the APC operation is sufficiently stabilized, and are markedly close to the target peak power and the target erase power. For this reason, in the APC operation of this embodiment, feedback control is started from the values fairly close to the target peak power or the target erase power. Consequently, as shown in FIG. 4D, a transient change Trans_p2 of the peak power system and a transient change Trans_e2 of the erase power system can be reduced markedly.

As a result, an unstable period Tw2 in this embodiment can be made much shorter than the unstable period Tw1 in the related art.

As described above, it is known that the driving-current to light-power characteristic (hereinafter referred to as an I-L characteristic) of the laser-light emitting element 33 depends on the temperature. For this reason, when the temperature of the laser-light emitting element 33 greatly changes during a playback mode (a playback period immediately preceding the current recording period) between the completion of the previous recording mode and the start of the current recording mode, the driving currents for obtaining the same target peak power and the same target erase power slightly differ.

In this case, Equations (1) and (2) indicating the initial APC values are corrected by changes in the driving amounts during the playback mode between the previous recording mode and the current recording mode. More specifically, the initial APC value of the peak power system is set as follows:
Ip_{O}(n)=Ip_{L}(n−1)+(Ir_{S}(n−1)−Ir_{L}(n−1)) (3)
where Ir_{S}(n−1) represents the read power driving amount immediately after the previous recording mode, and Ir_{L}(n−1) represents the read power driving amount immediately before the current recording mode. Similarly, the initial APC value of the erase power system is set as follows:
Ie_{O}(n)=Ie_{L}(n−1)+(Ir_{S}(n−1)−Ir_{L}(n−1)) (4)

On the other hand, in the bottom power system, open loop control (ACC) is exerted. The driving amount corresponding to the target bottom power is set in the bottom ACC DAC 51 by the CPU 70, and ACC is exerted with this set value (Step ST5).

During the recording mode, input-terminal signals (driving amounts) of the driving current sources 27a and 27b of the peak power system and the erase power system are input to an ADC 15 via an ADC input switch 17, and are read into the CPU 70 of the control unit 7. The driving amounts are sampled at an appropriate interval and held during the recording mode. In this case, only the latest driving amount may be held (Step ST6).

Steps ST4 to ST6 are repeated during the recording mode. When a playback mode (a current playback period) is started in response to a playback/recording switch signal (Step ST7), Step ST8 and subsequent steps are performed to exert APC on the read power system.

Steps ST8 to ST11 are performed for the read power system, instead of the peak power system (or the erase power system). Specific operations of the steps are the same as the above-described steps, and therefore, detailed descriptions thereof are omitted.

In an APC operation for the read power system, a transient change Trans_r2 can be reduced, as shown in FIG. 4D, by setting an initial APC value Ir_{O}(n) as follows:
Ir_{O}(n)=Ir_{L}(n−1) (5)
where Ir_{L}(n−1) represents the read power driving amount provided at the completion of the previous playback mode (a previous playback period, an immediately preceding playback period). As a result, an unstable period Tr2 immediately after the start of the playback mode is shortened.

Correction similarly to Equations (3) and (4) may be made by using a peak power driving amount (or an erase power driving amount) provided immediately after the previous playback mode and a peak power driving amount (or an erase power driving amount) provided immediately before the current playback mode.

While the laser driving device 6 exerts the above-described APC according to a received-light signal input from the power detector 34, it also exerts gain control (light-receiving sensitivity control) on the power detector 34.

The CPU 70 detects switching between the playback mode and the recording mode, and information for controlling the light-receiving sensitivity (light-receiving sensitivity information) is transmitted to the power detector 34 via the internal bus 14 of the laser driving device 6 according to a control signal from the signal bus 63. Further, light-receiving sensitivity information preset by the CPU 70 may be stored in the interface circuit 10 so that proper light-receiving sensitivity information corresponding to a playback mode and a recording mode is output to the power detector 34 in conjunction with a playback/recording switch signal included in the control signals from the signal bus 63.

This control of the light-receiving sensitivity can prevent saturation of the power detector 34 even when the light power is rapidly increased by switching from the playback mode to the recording mode, and can avoid divergence of APC due to saturation.

Not only the two light-receiving sensitivities of the power detector 34 for recording and playback, but also a plurality of light-receiving sensitivities for recording may be controlled.

In this case, the CPU 70 finds proper light-receiving sensitivities in accordance with the recording power, and information about the light-receiving sensitivities is input to the laser driving device 6 via the signal bus 63. Further, the information about the light-receiving sensitivities is output to the power detector 34 via the internal bus 14.

The use of the method for properly setting the sensitivity of the power detector 34 is effective when a light power stronger than an estimated power is output during an adjustment process for optimizing the recording power. Moreover, it is possible to use the dynamic range as effectively as possible, and to achieve more accurate control.

The present invention is not limited to the above-described embodiment, and can be carried out by modifying the components within the scope of the invention. The present invention also can be carried out by appropriately combining a plurality of components in the embodiment. For example, some of the components described in the embodiment may be omitted, or the components in different embodiments may be combined appropriately.

What is claimed is:

1. An optical disc apparatus comprising:
a laser-light emitting element configured to emit laser light onto a writable and readable optical disc;
a power detecting unit configured to detect a light power level of the laser light emitted from the laser-light emitting element; and
a power control unit configured to control a driving signal for the laser-light emitting element by feedback control so that the detected light power level coincides with a target light power level,
wherein the power control unit is configured to hold a driving signal level obtained during a previous recording period until a current recording period, and to use the held driving signal level as an initial driving signal level for the feedback control in the current recording period when the current recording period begins.

2. The optical disc apparatus according to claim 1, wherein the power control unit is configured to hold a driving signal level obtained during an immediately preceding recording period until the current recording period, and to use the held driving signal level as the initial driving signal level for the feedback control in the current recording period when the current recording period begins.

3. The optical disc apparatus according to claim 1, wherein the power control unit is configured to hold a driving signal level obtained during an immediately preceding recording period until the current recording period, and to use a driving signal level based on the held driving signal level and a driving level signal obtained from an amount of change in driving signal levels during a playback period immediately preceding the current recording period as the initial driving signal level for the feedback control in the current recording period when the current recording period begins.

4. The optical disc apparatus according to claim 1, wherein the power control unit is configured to hold a driving signal level obtained during a previous playback period until a current playback period, and to use the held driving signal level as an initial driving signal level for the feedback control in the current playback period when the current playback period begins.

5. The optical disc apparatus according to claim 4, wherein the power control unit is configured to hold a driving signal level obtained in an immediately preceding playback period until the current playback period, and to use the held driving signal level as the initial driving signal level for the feedback control in the current playback period when the current playback period begins.

6. The optical disc apparatus according to claim 4, wherein the power control unit is configured to hold a driving signal level obtained during an immediately preceding playback period until a current playback period, and to use the held driving signal level and a driving signal level obtained from an amount of change in driving signal levels during a recording period immediately preceding the current playback period as the initial driving signal level for the feedback control in the current playback period when the current playback period begins.

7. The optical disc apparatus according to claim 1, further comprising:
a sensitivity control unit configured to control the light-receiving sensitivity of the power detecting unit,
wherein the sensitivity control unit is configured to switch the light-receiving sensitivity when a recording period or a playback period begins.

8. The optical disc apparatus according to claim 7, wherein the sensitivity control unit is configured to switch the light-receiving sensitivity on the basis of the light power level detected by the power detecting unit.

9. The optical disc apparatus according to claim 1, wherein the power control unit comprises:
an error detector configured to detect an error between the detected light power level and the target light power level;
a capacitor configured to store the detected error as a driving voltage during the feedback control;
a controller configured to sample the driving voltage stored during the feedback control, to hold the sampled driving voltage, and to apply the held driving voltage as an initial value for the next feedback control to the capacitor; and
a voltage-current converter configured to convert the driving voltage stored in or applied to the capacitor into a driving current for driving the laser-light emitting element.

10. A laser-power control method comprising the steps of:
emitting laser light from a laser-light emitting element onto a writable and readable optical disc;
detecting a laser power level of the laser light emitted from the laser-light emitting element; and
controlling a driving signal for the laser-light emitting element by feedback control so that the detected light power level coincides with a target light power level,
wherein, in the control step, a driving signal level obtained during a previous recording period is held until a current recording period, and the held driving signal level is used as an initial driving signal level for the feedback control in the current recording period when the current recording period begins.

11. The laser-power control method according to claim 10, wherein, in the control step, a driving signal level obtained in an immediately preceding recording period is held until the current recording period, and the held driving signal level is used as the initial driving signal level for the feedback control in the current recording period when the current recording period starts.

12. The laser-power control method according to claim 10, wherein, in the control step, a driving signal level obtained during an immediately preceding recording period is held until the current recording period, and a driving signal level based on the held driving signal level and a driving signal level obtained from an amount of change in driving signal levels during a playback period immediately preceding the current recording period is used as the initial driving signal level for the feedback control in the current recording period when the current recording period begins.

13. The laser-power control method according to claim 10, wherein, in the control step, a driving signal level obtained during a previous playback period is held until a current playback period, and the held driving signal level is used as an initial driving signal level for the feedback control in the current playback period when the current playback period begins.

14. The laser-power control method according to claim 13, wherein, in the control step, a driving signal level obtained during an immediately preceding playback period is held until the current playback period, and the held driving signal level is used as the initial driving signal level for the feedback control in the current playback period when the current playback period begins.

15. The laser-power control method according to claim 13, wherein, in the control step, a driving signal level obtained during an immediately preceding playback period is held until the current playback period, and a driving signal level based on the held driving signal level and a driving signal level obtained from an amount of change in driving signal levels during a recording period immediately preceding the current playback period is used as the initial driving signal level for the feedback control in the current playback period when the current playback period begins.

16. The laser-power control method according to claim 10, further comprising the step of:
controlling the light-receiving sensitivity of the power detecting unit when detecting the light power level,
wherein the light-receiving sensitivity is switched in the sensitivity control step when a recording period or a playback period begins.

17. The laser-power control method according to claim 16, wherein the light-receiving sensitivity is switched on the basis of the detected light power level.
